(19) United States
(12) Patent Application Publication
(10) Pub. No.: US 2016/0330952 A1
(43) Pub. Date: Nov. 17, 2016

(54) ENCAPSULATION AND CONTROLLED RELEASE OF VOLATILE ORGANIC COMPOUNDS

(71) Applicant: UNIVERSITY OF GUELPH, Guelph (CA)

(72) Inventors: Loong-Tak Lim, Guelph (CA); Suramya D.F. Mihindukulasuriya, Guelph (CA); Gopinadhan Paliyath, Waterloo (CA); Jayasankar Subramanian, St. Catharines (CA); J. Alan Sullivan, Guelph (CA)

(21) Appl. No.: 15/111,363

(22) PCT Filed: Jan. 15, 2015
(86) PCT No.: PCT/CA2015/000027

§ 371 Date: Jul. 13, 2016

Related U.S. Application Data
(60) Provisional application No. 61/927,650, filed on Jan. 15, 2014.

(51) Int. Cl. A01N 3/00; A01N 25/28; A01N 25/34; A23B 7/154; A23L 3/3499; B05D 1/12; D01D 11/00; D01D 5/00; D01F 1/10; D01F 2/00; D01F 9/00; D01F 6/96; A01N 25/10; A23N 15/06

(52) U.S. Cl. CPC A01N 3/00; A01N 25/10; A01N 25/28; A01N 25/34; A23B 7/154; A23L 3/3499; A23N 15/06; D01D 11/00; D01D 5/003; D01F 1/10; D01F 2/00; D01F 9/00; D01F 6/96; B05D 1/12; A23V 2002/00

(57) ABSTRACT

The invention provides methods for the encapsulation of volatile organic compounds by formation of stable emulsions of the volatile organic compound that are mixed with encapsulating polymer solutions and then formed into ultrafine fibers. The ultrafine fibers containing the encapsulated volatile organic compounds can be formed into a variety of formats for use to preserve perishable products.

### FIELD OF THE INVENTION

The invention generally relates to the encapsulation of volatile organic compounds. More specifically, the invention relates to methods to make fiber compositions comprising polymer encapsulated volatile organic compound(s) (VOCs), as well as the compositions so produced. The invention further relates to packaging systems incorporating the fiber compositions of the invention and methods of improving/extending the shelf-life of perishable products. The fiber compositions of the invention can provide modified release kinetics for the volatile organic compound(s) encapsulated therein.

### BACKGROUND OF THE INVENTION

Horticultural products such as fresh fruits and vegetables are very perishable by nature and susceptible to spoilage due to fungi and bacteria infection. Many are also susceptible to mechanical injuries during post-harvest handling and distribution due to their soft tissues and perishable nature. This leads not only to substantial fruit and vegetable losses representing financial losses for the farmers, packers, and distributors, but also to increased solid waste that can have a negative environmental impact. From a food safety standpoint, perished fruits and vegetables can also impact consumers' health.

In response to consumers' preference for natural preservatives over the synthetic counterparts, the use of naturally occurring compounds to extend the shelf-life of fresh products has been increasing in the food industry over the past decade. Today, various natural volatile compounds have been used to increase the shelf-life of fresh products (Ko et al., 2012; Kostansek, 2002; Sharma et al., 2010). In particular, cyclopropene and methylcyclopropene have been used commercially to inhibit ethylene response in climacteric fruits such as apple and pear, thereby delaying the ripening process and extending their shelf-life. These volatile compounds act by blocking the ethylene binding sites in the plant tissues.

Besides ethylene receptor site blockers, other volatile compounds have also been used to extend the shelf-life of fruits and vegetables. For instance, due to their antimicrobial properties, allyl isothiocyanate, acetaldehyde, hexanal, and 2E-hexanal have been used to inhibit the growth of spoilage microorganisms in fresh fruits and vegetables (Almenar et al., 2007a; Sharma et al., 2010). In particular, hexanal, a 6-carbon aliphatic aldehyde, is recognized as a preservative to extend the shelf-life of fresh fruits and vegetables (Corbo et al., 2000; Lanciotti et al., 2004; Utto et al., 2008). Hexanal is a naturally occurring compound produced when plant tissues are disrupted. The efficacy of hexanal for shelf-life extension of fresh products was attributed to its antimicrobial properties, much similar to other aldehydes. However, hexanal also elicits cellular decay delaying effects in many fruits and vegetables (Gonzalez-Aguilar et al., 2010; Thavong et al., 2002; Utto et al., 2008). At the cellular level, hexanal has been reported to reduce the decay of plasma membrane in the cell by inhibiting phospholiphase D, which is the key enzyme that is responsible for the disruption of cellular membrane (Paliyath and Subramanian, 2009; Paliyath et al., 2003; Tiwari and Paliyath, 2011). Since hexanal is a naturally occurring compound with low toxicity (ORL-MAM LD₅₀ of 3700 mg/kg), it has been approved by U.S. Food and Drug Administration to be used as a food additive.

Although hexanal is beneficial for extending the shelf-life of fresh products, it is highly volatile and gets quickly released from the application point. This property is not ideal for many post harvest applications due to the lack of control in terms of providing optimal release profiles and poor storage stability. U.S. Pat. No. 7,198,811 discloses hexanal compositions for use to preserve produce. The compositions are applied to the produce. However, such compositions are not stable over a long period of time with respect to the release of hexanal.

To overcome these shortcomings, it has been proposed to encapsulate hexanal. Almenar et al. (2007b) encapsulated hexanal in α-cyclodextrin. U.S. 2007/0207981 discloses systems for encapsulating hexanal in a cyclodextrin matrix to prevent its uncontrolled release. Although encapsulated, there is no controlled activation of the hexanal release nor can the release be modified for a particular application.

Therefore there remains a need to provide a method for encapsulating desired volatile organic compounds for general controlled release in desired manner that can be tailored for various applications relating to perishable products and in other applications where controlled release of VOCs would be beneficial.

### SUMMARY OF THE INVENTION

The present invention provides a novel method to encapsulate volatile organic compounds (VOCs) and further provides methods to encapsulate volatile organic compounds (VOCs) with a controlled release profile. The methods can be used with a variety of VOCs that have preservative qualities for a variety of perishable products.

In the method of the invention, a fibrous composition is produced comprising a polymer matrix that encapsulates a VOC within the polymer matrix. In aspects various VOC binding compounds can be incorporated into the polymer matrix in order to further alter the release kinetics of the encapsulated VOC. This is advantageous in order that the release kinetics can be designed for a perishable product and/or packaging material.

The method of the invention is suitable for the encapsulation and release of any variety of VOC as desired. In aspects the VOC are selected that have use in the preservation of perishable products. Perishable products may include edibles such as but not limited to cut and uncut fruits, vegetables, flowers, other horticultural products and prepared foods that contain fresh fruits and vegetables. Still in other embodiments, the perishable product is not one for human consumption but rather a fragrance product or a cosmetic product.

The invention is therefore also directed to a fiber composition comprising volatile organic compounds (VOC) encapsulated within a polymer matrix and optional VOC binding compound to alter the release kinetics of the VOC from the matrix. The fiber compositions have direct use in a variety of formats for increasing the shelf-life of perishable products in a variety of environments. The VOC binding compound alters the release kinetics of the embedded VOC as different types of perishable products may require a different VOC release profile to extend their shelf-life.

The fiber composition produced by the methods of the invention has several advantages as the fibers provide a slow release of the VOC over a long period of time by suppressing the diffusion of the VOC. Desirable release profiles optimized for a specific application or a product are achievable by the alteration of the matrix and/or changing the structure of the fiber matrix, i.e. manipulating the morphology of the matrices. Such release profiles are achieved in aspects by the addition of a VOC binding compound within the matrix.

According to an aspect of the present invention is a method for the encapsulation of a volatile organic compound, the method comprising:
preparing a stabilized system of organic polymer, surfactant, and at least one volatile organic compound;
mixing an encapsulating polymer solution with said stabilized system to form a fiber forming solution; and
producing ultrafine fibers from the fiber forming solution, wherein said fibers comprise said encapsulated VOC.

According to an aspect of the present invention is a method for the encapsulation of a volatile organic compound, the method comprising:
preparing a stable emulsion of polymer, surfactant, at least one volatile organic compound and a VOC binding agent;
mixing an encapsulating polymer solution with said stable emulsion to form a fiber forming solution; and
producing ultrafine fibers from the fiber forming solution, said ultrafine fibers comprising said encapsulated VOC.

According to another aspect of the present invention is a method for the encapsulation of a volatile organic compound, the method comprising:
preparing a stabilized system of organic polymer, surfactant, at least one volatile organic compound and a VOC binding agent;
mixing an encapsulating polymer solution with said stabilized system to form a fiber forming solution; and
electrospinning said fiber forming solution to produce ultrafine fibers.

According to another aspect of the present invention is a method for the encapsulation of a volatile organic compound having preservative qualities for perishable foods, the method comprising:
mixing one or more volatile organic compounds with a surfactant to form a conditioned mixture;
adding a polymer to said conditioned mixture and forming a stabilized system at about room temperature;
mixing an encapsulating polymer solution with said stabilized system to form a fiber forming solution; and
producing ultrafine fibers from the fiber forming solution.

According to another aspect of the present invention is a method for the encapsulation of a volatile organic compound for preserving perishable edible products, the method comprising:
mixing hexanal with triethanolamine to form a conditioned mixture;
adding xanthan gum to said conditioned mixture and forming a stable emulsion at room temperature;
mixing an encapsulating polymer solution comprising polyethylene oxide with said stable emulsion to form a fiber forming solution; and
electrospinning the fiber forming solution to form ultrafine fibers.

According to another aspect of the present invention is a method for the encapsulation of a volatile organic compound, the method comprising:
mixing hexanal with triethanolamine to form a conditioned mixture;
adding xanthan gum to said conditioned mixture and forming a stable emulsion at room temperature;
adding one or more hexanal-binding agents to said stable emulsion;
mixing an encapsulating polymer solution comprising polyethylene oxide with said stable emulsion to form a fiber forming solution; and
electro-spinning the fiber forming solution to form ultrafine fibers.

In aspects of the invention, the fibers are provided as a composition. According to another aspect of the present invention is a composition that comprises fibers of a polymer matrix encapsulating a VOC. The composition can be provided in a variety of formats such as coating/film/liner/insert/membrane for use on fabric, paper products, metals and plastics. The may be provided as a mat or lining suitable as an insert for packaging/container systems.

According to yet another aspect of the present invention is an ultrafine fiber composition, the composition comprising one or more polymer encapsulated volatile organic compounds.

According to another aspect of the present invention is an extended release ultrafine fiber composition, wherein the composition comprises one or more volatile organic compounds.

According to a further aspect of the invention is an electrospun ultrafine fiber composition comprising: ultrafine fibers comprising organic polymer, surfactant and one or more volatile organic compound and an encapsulating polymer.

According to yet another aspect of the present invention is an ultrafine fiber membrane, the membrane comprising one or more polymer encapsulated volatile organic compounds. In aspects, the membrane can be layered.

Compositions may be provided in a variety of formats designed for certain applications such as but not limited to a patch, mat, or as applied to a substrate as a lining or coating, the substrate being a paper, plastic and/or fabric. Combinations of formats are envisaged and within the scope of the present invention.

According to further aspect of the present invention are fibers comprising a polymer matrix and encapsulated volatile organic compound, wherein the matrix provides for a desired release kinetic of the volatile organic compound.

According to further aspect of the present invention are a combination of fibers and particles comprising a polymer matrix and encapsulated volatile organic compound, wherein the matrix is designed for a desired release kinetic of the volatile organic compound.

According to another aspect of the present invention are electrospun fibers comprising a polymer matrix encapsulating a volatile organic compound and optional VOC-binding agent.

According to another aspect of the present invention are electrospun fibers comprising a polymer matrix encapsulating hexanal and a temperature sensitive substance that imparts different release kinetics for the hexanal. In aspects the temperature sensitive substance is one or more of a fat, wax, synthetic polymer, biopolymer, oil and combinations thereof.

The invention also encompasses methods to preserve perishable products, where the method comprises providing the fiber compositions of the invention in proximity with a desired perishable product.

The invention also encompasses methods to release fragrances, where the fiber composition of the invention is formulated to further comprise a fragrance as the VOC.

According to a further aspect of the invention is a container for retarding decay, maturation and senescence of perishables, including but not limited to fruits, vegetables and florals, in postharvest circumstances which comprises a lining, coating or insert comprising electrospun fibers comprising a polymer matrix encapsulating a volatile organic compound and optional binding compound.

According to another aspect of the present invention is a method of packaging perishable food or horticultural products comprising:
enclosing the perishable food or horticultural product in a container which comprises a format comprising fibers of a polymer matrix encapsulating a volatile organic compound and optional VOC binding compound.

According to another aspect of the present invention is a method for increasing the shelf-life of perishable food or horticultural products, the method comprising:
enclosing or placing adjacent the perishable food or horticultural product with a composition comprising fibers of a polymer matrix encapsulating a volatile organic compound and optional VOC binding compound.

According to another aspect of the invention is a composition comprising a polymer matrix encapsulating a fragrance product for controlled release of the fragrance product. The composition may further comprise one or more binding agents that bind to the fragrance product for a modified controlled release of the fragrance product. The composition may be provided in a variety of formats such as but not limited to a patch or a mat or as applied to a substrate of a paper, plastic and/or fabric.

According to an aspect of the invention is the use of an ultrafine fiber composition comprising one or more polymer encapsulated volatile organic compounds, in a packaging, storing or transportation system to improve the shelf-life of perishable products.

According to an aspect of the invention is the use of an ultrafine fiber composition comprising one or more polymer encapsulated volatile organic compounds, to improve the shelf-life of perishable products.

According to an aspect of the invention is the use of an ultrafine fiber composition comprising one or more polymer encapsulated volatile organic compounds, to retard decay, maturation and senescence of perishables selected from fruits, vegetables and florals.

According to an aspect of the invention is the use of an ultrafine fiber composition comprising one or more polymer encapsulated volatile organic compounds for the enhancement, maintenance or extension of the lifetime of the organoleptic qualities of a perishable edible product. Organoleptic properties can include color, sweetness, taste, flavor, storage-lifetime, nutritional quality, firmness or combinations thereof.

According to a further aspect of the invention is a carrier system for the controlled release of a volatile organic compound, said carrier system comprising electrospun ultrafine fibers of a diameter of up to about 500 nm, the ultrafine fibers comprising a biopolymer, surfactant and encapsulating polymer.

Other features and advantages of the present invention will become apparent from the following detailed description. It should be understood, however, that the detailed description and the specific examples while indicating embodiments of the invention are given by way of illustration only, since various changes and modifications within the spirit and scope of the invention will become apparent to those skilled in the art from said detailed description.

### BRIEF DESCRIPTION OF THE DRAWINGS

FIG. 1 shows the experimental setup that used for electrospinning of polymer solution containing hexanal According to the release kinetics data, it is apparent that release rate is lower in hydroxypropylmethylcellulose (HPMC) based formula than xanthan based formula.

FIG. 2 shows the release of hexanal from electrospun fibers at 20° C. and 100% RH (relative humidity); comparison between xanthan based formula and HPMC based formula.

FIG. 3 shows the release of hexanal from electrospun fibers at 20° C. and 100% RH; comparison between xanthan based formula and electrospun double membrane (PEO layer on xanthan based formula).

FIG. 4 shows the release of hexanal from electrospun fibers at 20° C. and 100% RH; comparison between the formula that contains higher PEO ratio (PEO: xanthan+hexanal+TEA ratio (4:1)) verses lower PEO ratio (PEO: xanthan+hexanal+TEA ratio (2:1)).

FIG. 5 shows the release of hexanal from the electrospun fibers at 20° C. and 100% RH; comparison between the formula that contains higher hexanal amount (0.32 g) verses lower hexanal amount (0.16 g).

FIG. 6 shows the release of hexanal from electrospun fibers at 23° C. and 100% RH; comparison between xanthan gum based formula and pectin based formula.

FIG. 7 shows the release of hexanal from electrospun fibers at 23° C. and 85% RH; xanthan based formula modified with carnuaba wax.

FIG. 8 shows the release of hexanal from the electrospun fibers at 23° C. and 45° C. and 85% RH; base formula, base formula modified with carnauba wax, and base formula modified with paraffin oil.

FIG. 9 shows the release of hexanal from electrospun fibers at 5° C., 20° C. and 45° C. with 100% RH; base formula was used in this study.

FIG. 10 shows the release of hexanal from electrospun fibers at 20° C. with 100% RH; comparison between xanthan gum based formula and cyclodexrine based formula.

FIG. 11 shows the cumulative release of hexanal from the electrospun fibers exposed to 50 and 85% RH at 23° C., for electrospun membrane prepared using the base formula.

FIG. 12 are scanning electron micrographs showing that the fiber diameters of hexanal carrier systems ranged from 300 to 500 nm. Diameter of the fibers produced with base formula, carnauba wax based formula, and paraffin oil base formula was 371±72, 358±90, and 473±85 nm, respectively.

### DETAILED DESCRIPTION OF THE INVENTION

The present invention provides a method to encapsulate volatile organic compounds (VOCs) in a manner that its release is controlled for extended periods of time. The method further provides that the extended release of the VOC can further be altered by reducing the mobility of the VOC to provide optimum release profiles for a specific application or product. The method comprises forming a fiber composition that encapsulates the VOC in a controlled release manner. The composition can then be used to improve the shelf life of perishable products. The perishable products are in aspects, edible perishable products. Still in other aspects, the perishable products can be non-edible such as floral and fragrance products and for cosmetics.

By preserving the shelf life, is meant the enhancement, maintenance or extension of the lifetime of the organoleptic qualities of the perishable edible product. Organoleptic properties can include color, sweetness, taste, flavor, storage-lifetime, nutritional quality, firmness or combinations thereof.

There are relatively common factors which come into play in maintaining continued quality of a perishable product after it has been harvested. These three factors in all relate to the interplay between the harvested perishable and the nearby atmosphere. The factors are the respiration rate of the fruit, the ambient temperature and the ambient relative humidity. All factors are interdependent on one another. While a general rule cannot be developed which will describe the relationship of these three variables to all perishables, and, indeed, different perishables may act in contrary fashion to other perishables, the generalization nevertheless remains true that these factors are important in the postharvest deterioration, through maturing, senescence or deterioration, of the invitation of mold or fungi development.

The methods of the invention help to control the typical perishable optimum conditions of respiration rate, temperature and relative humidity in postharvest conditions which will enable the fruit, vegetable or floral to delay or avoid the onset of decay, premature deterioration or premature maturation. The release profile of the VOC can be altered at different relative humidity (RH) as the fibrous structure may be collapsed with the absorption efficiency of moisture.

Therefore the methods of the invention that encapsulate volatile organic compounds, such as for example hexanal, are beneficial for farmers and producers of agricultural products to enhance the stability of fresh fruits and vegetables using naturally occurring compounds, increasing their competitiveness in the domestic and international marketplaces. In addition, the invention will benefit the food packaging industry, where for example hexanal encapsulated compositions of the invention can be exploited in modified atmosphere packaging applications for fresh produce, as well as other applications.

For non-edible perishable products, preserving shelf life would be understood that the selected VOC that is encapsulated would have a desired release profile such that for example, the cosmetic is preserved due to reduction of microbial growth.

In general, the method of the invention is applicable to a variety of volatile organic compounds. In one aspect, the volatile organic compounds for use in the present method may be in general C₆ aldehydes, C₆, alcohols, monoterperne aldehydes and monoterpene alcohols. The volatile organic compounds can be selected from those that inhibit ethylene release and those that inhibit the growth of spoilage microorganisms and well as combinations of both. Representative but non-limiting examples of suitable volatile organic compounds include but are not limited to cyclopropene and methylcyclopropene (inhibit ethylene response) as well as allyl isothiocyanate, acetaldehyde, hexanal, and 2E-hexanal (antimicrobial properties). Volatile organic compounds may also include those having anti-fungal properties such as cinnamic acid, 1-methylcyclopropene, isoprene and terpenes. Still other suitable VOC for use in the invention can include but is not limited to jasmonate, benzaldehyde, propanal, butanol, ethanol, acetic acid, thymol, eugenol, citral, vanillin, trans-cinamaldehyde, salicyclic acid, furfural, geraniol, 2-nonanone, cis-3 hexen-1-ol and methyl. It is understood to one of skill in the art that any combination of such volatile organic compounds can be used in the method and compositions of the invention as understood by one of skill in the art. Thus the method and compositions are not limited by any type of VOC.

In the method the volatile organic compound or desired mixture thereof is mixed with a surfactant. The surfactant in aspects is a food grade surfactant and can be selected from the group consisting of triethanolamine (TEA), glycerol, triethylene glycol (TEG), Tween 20, Tween 40, polysorbates, Span 80, Span 85, PEG (polyethylene glycol), lecithin and combinations thereof. However, it is understood by those of skill in the art that other compounds that can reduce the vapor pressure of the volatile organic compound and the interfacial energy between the dispersed and continuous phases in the method can be used. In a non-limiting representative aspect, TEA is used in the method. The ratio of volatile organic compound:surfactant used in the method is about 1:5 but may range from about 1:5 to about 1:2.

The mixture of volatile organic compound and surfactant is then mixed with about 0.005% to about 0.01% biopolymer. Suitable biopolymers for use in the method include but are not limited to a variety of polysaccharides such as pectin, alginate, guar gum, carrageenan, waxy corn starch and mixtures thereof as well as proteins such as but not limited to zein, chitosan, gelatin, soy/whey protein isolates and mixtures thereof. Mixtures of polysaccharides and proteins are also envisaged.

The ratio of volatile organic compound/surfactant to biopolymer is about 1:5 for mixing, however, a range of about 1:3 to about 1:10 is suitable. One of skill in the art would understand the amount of volatile organic compound or mixture thereof to incorporate based on the intended application.

The resulting volatile organic compound, surfactant and biopolymer mixture is maintained essentially at room temperature for a time sufficient to provide a stabilized system of VOC/biopolymer/surfactant. The time may be at least about 48 hours or more. The stabilized system may be in the form of an emulsion, dispersion or solution and is then admixed with an aqueous polymer solution that comprises the encapsulating polymer. The encapsulating polymer for use in the solution should be sensitive to water but can be dissolved in selected hydrophobic solvents. Suitable encapsulating polymers may be synthetic polymers such as but not limited to polyethylene oxide (PEO), polyvinyl acetate (PVA), hydroxypolymethylcellulose (HPMC), poly(vinylpyrrolidinone)(PVP), poly(acrylic acid)(PAA), poly(methacrylic acid, polyethylenimine (PEI), PDMS (polydimethylsiloxane), nylon, poly(lactic acid) and mixtures thereof provided in a compatible solvent system such as ethanol. Concentration ranges for the encapsulating polymer are about 2-5% (w/w) and in aspects 4% (w/w) in about 0-40% ethanol (v/v). In aspects about 30% ethanol may be used.

Mixing ratios of the emulsion of volatile organic compound/surfactant/biopolymer to aqueous encapsulating polymer solution is about 1:1 to about 1:5. This mixture forms the fiber forming solution.

The fiber forming solution is then formed into fibers by a variety of suitable methods such as by electrospinning, solution dry spinning, melt blown, and dispensing using pressurized air jets. In aspects of the invention, the technique of electrospinning is utilized as is described herein in the examples. Electrospinning uses an electrical charge to draw very fine (typically on the micro or nano scale) fibers from a liquid. Electrospinning of the fiber forming solution creates fibers of encapsulated volatile organic compound within the polymer matrix. The solution parameters of the electrospinning can be altered to provide different electrospun fiber structures and component ratios as is understood by one of skill in the art. For example, the electrospun fibers may create a membrane or composite membrane, and one of skill in the art could create a multi-layered membrane by sequential electrospinning or utilizing more than one nozzle to concurrently electrospin a multilayered membrane. Electrospun fibers can be up to about 500 nm in diameter. In aspects between about 300 to 500 nm. These may be characterized as ultrafine.

As is understood by one of skill in the art, the methodology to form fibers of the composition of the invention is not limiting so long as fibers are formed and in aspects, the fibers are ultrafine. Characterization of the fibers so produced by the method of the invention can be achieved by scanning electron microscopy, transmission electron microscopy, use of a confocal microscope, by light microscopy and using an atomic force microscope, Fourier transform infrared spectroscopy.

Electrospraying of the composition may also be desirable to deposit VOC encapsulated particles in combination with the fibers of the invention. In this manner, the release profile of the encapsulated VOC can be further tailored to a specific embodiment.

Electrospinning of the fiber forming solution creates a composition of electrospun fibers wherein the volatile organic compound is encapsulated within the polymer matrix for controlled release. This composition can be provided in a variety of formats such as a film, membrane, coating, sheet or multi-layered film, membrane, coating or sheet. As a multi-layered in the various formats, combinations of VOC can be provided per sheet/coating/membrane or in combinations in layers of the sheet/coating/membrane as desired.

The fiber composition of the invention can be applied to any desirable substrate such as papers, plastics, fabrics, synthetic polymer sheets and packaging materials. The fiber composition of the invention can also be provided as an insert or patch and inserted into various types of packaging materials for perishable products.

In further embodiments of the invention, different release kinetics of the encapsulated volatile organic compound can be achieved by reducing the mobility of the volatile organic compound by incorporating a binding agent into the stabilized mixture as described above. The binding agent binds the volatile organic compound as incorporated into the stabilized system (volatile organic compound/surfactant/biopolymer) prior to the mixture with the encapsulating polymer. The ratio of the VOC binding agent to volatile organic compound/surfactant/biopolymer is about 1:2 or higher, in aspects about 1:3.

The binding agent in general is a heat-sensitive substance. The binding agent can be selected from the group consisting of paraffin oil, carnauba wax, bee wax, cocoa butter and mixtures thereof. Mixtures can be used to fine-tune the melting point of the binding agent. Different release kinetics can be achieved due to the fact that the binding agent is temperature (heat) sensitive. Thus the selection of binding agent is useful in systems where a different release profile of the volatile organic compound is desired due to the type of perishable product, where it is being shipped/stored, etc, as would be understood by one of skill in the art.

As encapsulated within a lipid crystal network such as those exist in coco butter or other saturated fats that have a melting point greater than the ambient temperature, the release of the volatile organic compound is activated when the temperature is elevated above the melting temperature of the lipid crystals. In this non-limiting application, the volatile organic compound such as hexanal can be mixed with the liquid state fat and during solidification, it can be entrapped within the fat crystal network. By incorporating either a biopolymer or synthetic polymer, or a blend of these two polymers in a suitable solvent, hexanal can be encapsulated effectively entrapped within the fat crystal network without causing substantial loss during the fiber formation process, such as during electrospinning.

It is also within the scope of the present invention to use semi-crystalline polymers to entrap the VOC according to the glass transition temperature. Polymers such as nylong and PLA (polylactic acid) reach the glass transition temperature, the VOC may be entrapped within the polymeric structure.

As encapsulated in an aqueous wax formulation, the VOC such as hexanal can be differentially released. Different waxes and oils can be used to encapsulate hexanal in a polymer matrix soluble in water. The development of an aqueous wax formula to encapsulate hexanal and can be prepared conveniently using an electrospinning technique or similar technique where ultrafine fibers can be formed.

The embodiment of the invention incorporating a binding agent selected from wax, oil and cocoa butter in the method is very suitable for electrospinning to create a composition of fibers with encapsulated hexanal, for example, with a desired kinetic release profile to use with perishable foods and other agricultural products.

In aspects, the electrospun fiber composition of the invention is used in conjunction with perishable products, and packaging for such products or simply in the vicinity of perishable edible products such as fruits, vegetables and the like to increase shelf life after harvesting and during transportation, handling thereof, sale, etc. As such, the compositions of the invention can be formatted into films used for food packaging, or storing or incorporated as part of the packaging in the lids, containers, etc. or provided as an insert into any type of desired packaging. Any application is desirable so long as the composition of the invention is in close proximity to the perishable product.

Among the several aspects of the present invention may be noted the provision of a liner for placement in a container to inhibit spoilage of perishable items held in the container; the provision of such a liner which inhibits growth of mold; the provision of such a liner which inhibits growth of bacteria; the provision of such a liner which is safe to handle; the provision of such a liner which is lightweight; and the provision of such a liner which does not retain water.

In aspects of the invention, the compositions of the invention can be fabricated as a fragrance “perfume patch” for timed release of fragrance. The patch can be adhered to the skin by a layer of pressure sensitive adhesive to emit a desired level of fragrance outwardly away from the skin of the user and directly from the perfume patch, over an extended period by a controlled time-release mechanism. The release of the fragrance is functional on the formulation of the composition with respect to the VOC binding compound. In this aspect, the VOC itself may comprise a fragrance.

In other aspects, the compositions of the invention can be used with fragrance release paper. Sampler devices for use in connection with promotion of the sale of fragrances and other products are typically inserted into magazines and catalogs, are used as statement enclosures, or are handed out individually by salespersons at retail establishments. Such samplers typically are of a non-laminar construction and comprise one sheet of a substrate, such as paper, which sheet is temporarily bonded to itself with an adhesive. The compositions of the invention can be used to encapsulated fragrances and be disposed within the adhesive, such that the adhesive both bonds the encapsulated fragrance to the substrate sheet and binds together the interior faces of the substrate sheet. When a user separates the sheets the fragrance encapsulated therein will be released for the user. A layer of a barrier material, such as a plastic or metal foil, may be utilized to overwrap the sampler to prevent leakage of the fragrance from the sampler.

To summarize, the present invention provides different engineered volatile organic compound compositions as delivery systems with different release profiles at different temperatures and environmental conditions. These have use in a variety of commercial embodiments including the food industry, floral industry and perfume/cosmetic industry.

Unless defined otherwise, all technical and scientific terms used herein have the same meaning as commonly understood by one of ordinary skill in the art to which this invention belongs. Although any methods and materials similar or equivalent to those described herein also may be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural references unless the context clearly dictates otherwise. All technical and scientific terms used herein have the same meaning.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges which may independently be included in the smaller ranges is also encompassed within the invention, subject to any specifically excluded limit in the stated range. Where the stated range includes one or both of the limits, ranges excluding either both of those included limits are also included in the invention.

Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Examples

The following examples are put forth so as to provide those of ordinary skill in the art with a complete disclosure and description of how to make and use the present invention, and are not intended to limit the scope of the present invention nor are they intended to represent that the experiments below are all or the only experiments performed.

### Materials

PEO (900 kDa), xanthan gum, gum arabic, pectin, triethanolamine (TEA), glycerol, zein, waxy corn starch, paraffin wax, and paraffin oil were purchased from Sigma-Aldrich (Sigma-Aldrich, ON, Canada). Glycerol (certified ACS) was purchased from Fisher Scientific (Fisher Scientific, NJ, USA). Hexanal, paraffin oil, and coco butter were purchased from Sigma-Aldrich (Sigma-Aldrich, ON, Canada).

### Methods

### Example 1

### Base Formula-Preparation of Xanthan Gum Based Formula for Electrospinning

An aqueous solution of 30% (v/v) ethanol was prepared by mixing 30 mL anhydrous ethanol with 70 mL deionised water. PEO powder was dispersed into the aqueous ethanol to produce a 4% (w/w) polymer solution by mixing 4 g of PEO with 96 g of 30% (v/v) ethanol for 1 h using a mechanical agitator. Xanthan gum solution, at 0.01% (w/w) concentration, was prepared by dissolving 0.3 g of gum in 29.7 g of deionised water at 60° C. under shear using a magnetic stirrer.

In this method, hexanal was first dissolved in TEA (hexanal:TEA 2:10 by weight) to depress the vapour pressure of hexanal. Moreover, TEA is compatible in both hydrophobic and hydrophilic mediums. Although TEA is the preferred dispersant in this formula, glycerol and triethylene glycol (TEG) can also be used as well as comparable surfactants. One gram of the hexanal:TEA mixture was mixed with 5 g of the pre-prepared 0.01% gum xanthan solution. This mixture was kept for at least 48-72 hours. Due to strong interaction between xanthan gum and TEA-hexanal mixture, a stable milky solution was obtained after 48-78 hours. Five grams of the resultant milky solution was mixed with 10 g of pre-prepared 4% PEO in 30% ethanol for 20 min by using a magnetic stirrer. This formula can be modified by simply adding other polysaccharides such as guar gum, carrageenan, pectin, waxy corn starch, as well as proteins, such as zein, gelatin, chitosan, soy/whey protein isolates.

### Electrospinning of Fiber-Forming Solutions

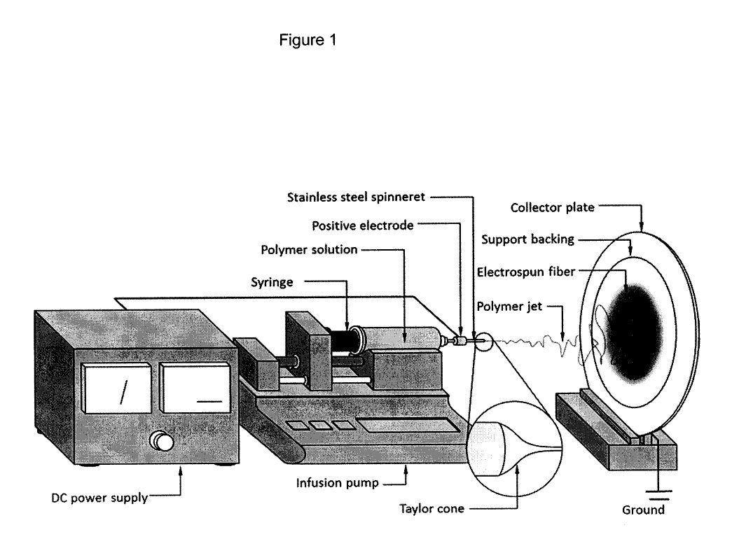

The fiber-forming solution was fed into a 3-mL disposable plastic syringe fitted with a 20-gauge blunt-end stainless steel needle spinneret (FIG. 1). The syringe was connected to an infusion pump (Model 780100; KD Scientific Inc., Holliston, Mass., USA). The positive electrode of a direct current power supply (Model ES30R-5 W/DM; Gamma High Voltage Research, Ormond Beach, Fla., USA) was attached to the spinneret. The ground electrode was attached to a circular stainless steel collector (26.5 cm diameter). The collector was covered with a layer of white paper or aluminum foil on which the fibers were deposited. The flow rate applied was 1-2.5 ml/h. The distance between the collector plate and needle tip was fixed at 20-24 cm. DC voltage, ranging from 16 to 20 kV, was applied to initiate polymer jetting. The electrospinning process resulted in a non-woven membrane deposited on the collector. All experiments were conducted at room temperature (22±2° C.). The electrospinning parameters for the fiber forming solution that used in each example are shown in Table 1.

TABLE 1
Electrospinning parameters used for fiber
forming solution to produce the fibers

| | | Distance between | |
|---|---|---|---|
| Example | Voltage | the collector and | Flow |
| (ml/h) | (kV) | spinneret (cm) | rate |
| 1- Base formula | 15-16 | 24 | 1 |
| 2- Carnauba wax with base formula | 15-16 | 20-24 | 2.5 |
| 3- Paraffin oil with base formula | 15-16 | 22 | 1 |
| 4- Coco butter with base formula | 15-16 | 24 | 1 |

### GC Analysis of Electrospun Fibers

Release kinetics of hexanal from the electrospun membranes were evaluated by enclosing known amount of fibers in a hermetically sealed 960 ml glass bottles, and the headspace air was analyzed using a gas chromatograph (GC). The GC operation parameters were as follows: constant oven temperature at 90° C., FID temperature 200° C., H₂ flow rate 30 mL/min, N₂ carrier flow rate 30 mL/min, and air flow rate 200 mL/min while the purging N₂ flow rate at 80 mL/min. Under these operating conditions, the hexanal was eluted at 3.9 min. A capillary column HP-1 (crosslinked methyl siloxane) with dimensions of 30 m×0.530 mm×2.65 mm was used in the GC. Calibration curve was developed based on known concentration (0.5-2.5 μl/L) of hexanal to quantify the release in to the headspace of the test jars.

### Scanning Electron Microscopy (SEM) Analysis of Electrospun Fibers

Morphology of the fibers were analyzed using SEM. Samples were coated with gold (20 nm) with a sputter 196 coater (Model K550; Emitech, Ashford, Kent, England) prior to SEM analysis. SEM micrographs were taken using 198 a model S-570 (Hitachi High Technologies Corp., Tokyo, 199 Japan) at 10 kV accelerating voltage. The average diameter that was reported herein was the average of 100 different fiber measurements.

Example 1 illustrated the efficacy of xanthan gum and PEO fibers for entrapping hexanal. However, this invention is not limited to xanthan gum. Other gums such as guar gum, carrageenan, gum arabic, pectin, and so on can be used for this purpose. Xanthan gum is a hydrophilic biopolymer produced by Xanthomonas campestris. A linear backbone of its main chain comprises 1, 4-linked-D-glucose. On the other hand, PEO is a biodegradable synthetic polymer. Both of these polymers are miscible when mixing at 40% or below 40% of gum xanthan with PEO in the blend (Basavaraju et al., 2007).

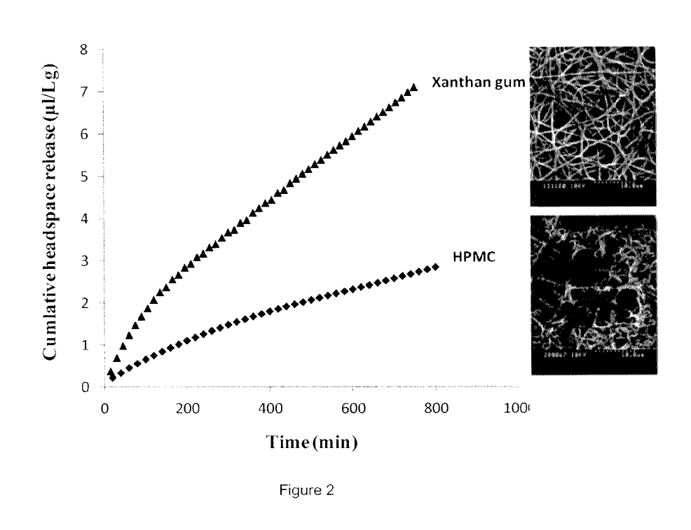

FIG. 2 shows the comparison of cumulative release of hexanal (μl/L·g) from the electrospun fibers developed with xanthan gum/PEO and (HPMC)/PEO blends. It is apparent from the data that electrospun fibers made by xanthan gum based formula released more hexanal at a higher rate at 23° C. compared with HPMC. The entrapment of more hexanal by xanthan gum fiber is likely due to the higher stability of the emulsion formed as compared with HPMC. The emulsion is a dispersion of one liquid as a form of droplets in an another immiscible liquid, the stability of which can be determined by the changes of its physiochemical properties within the time scale of the experiment (Mirhosseini et al., 2008). The emulsion stability is also affected by the interactions involved between the emulsion droplets such as van der Waals and repulsive forces. The mixture of hexanal, TEA, and xanthan gum is an oil/water emulsion. In this mixture, hexanal and xanthan gum solutions are immiscible. The continuous phase is formed by xanthan gum dissolved in water, and dispersed phase formed by hexanal droplets. TEA served two important purposes by firstly reducing vapour pressure of hexanal. Secondly, TEA is an emulsifier that stabilizes the dispersed lipophilic hexanal phase in the xanthan gum/PEO solution. The resultant milky solution obtained after mixing TEA, hexanal, and gum xanthan was more stable compared with HPMC based solution, judging from the rate of macroscopic separation. This observation is likely due to the weaker interaction between HPMC, hexanal, and TEA mixture as compared with gum xanthan and TEA mixture. PEO tends to interact strongly with HPMC, which might have reduced the hexanal-PEO or hexanal-HPMC binding sites in the electrospun fiber matrix. In xanthan gum based formula, the potential interaction sites of xanthan-PEO will be occupied by water, because xanthan gum is more hydrophillic than HPMC (Talukdar et al., 1996). This may have strengthened the hexanal-PEO and hexanal-xanthan interactions. As a result, the crystallinity of the electrospun fibers may be higher in xanthan-based formula due to less disruption of chain packing because of the presence of PEO. Xanthan gum in aqueous medium forms strong three dimensional gel network, whereas HPMC in an aqueous solution results in a viscous liquid (Talukdar and Kinget, 1997). It is conceivable that hexanal was trapped in the 3D network of the xanthan gum more readily than the HMPC solution. The hydrophobic moiety of hexanal likely interacts with the ethylene stretches of the PEO backbone. As water evaporates during the electrospinning process, dry fiber matrices are formed that encapsulate hexanal molecules that interact with the PEO. By contrast, in the HPMC formulation, HPMC might have interacted more strongly with PEO, thereby displacing some of the available cites for hexanal. Consequently, during the electrospinning process, hexanal tends to evaporate along with the solvent. The slower release profile observed for HPMC, as compared with xanthan gum, can be attributed to the reduced encapsulation efficiency of hexanal in the HPMC/PEO matrices.

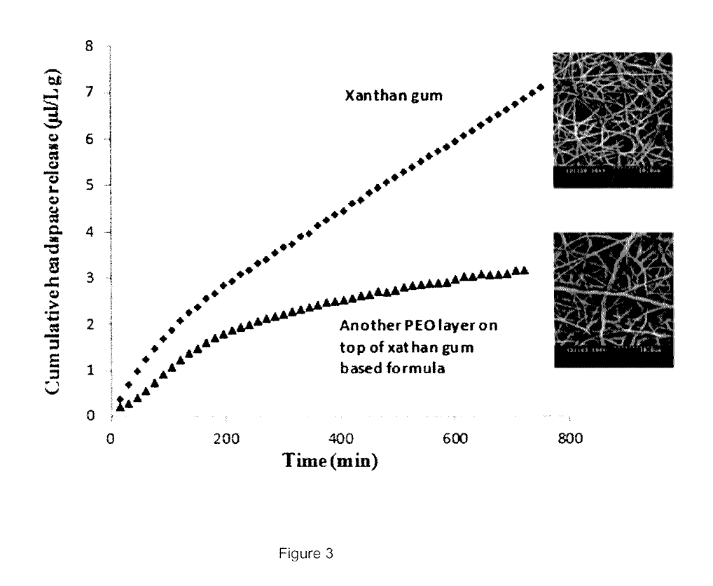

The release kinetics of hexanal can be changed by altering the structure of the electrospun membrane. As seen in FIG. 3, the structure of the electrospun membrane was changed by positioning another electrospun PEO layer on top of hexanal encapsulated electrospun fibrous layer produced by xanthan-based formula. It is apparent from FIG. 3 that the release rate can be reduced by nearly 10 times by applying another electrospun polymer layer on top of the xanthan-based fiber. The calculated release rate of hexanal at its initial 200 min from electrospun fibers made without another PEO fiber layer was 0.0128 μl/L·g·min, while membrane overlaid with electrospun PEO fibers was 0.009 μl/L·g·min. It is clear from this example that the desired release kinetics for a specific fruit or vegetable can be achieved by strategically producing multilayers of electrospun structures.

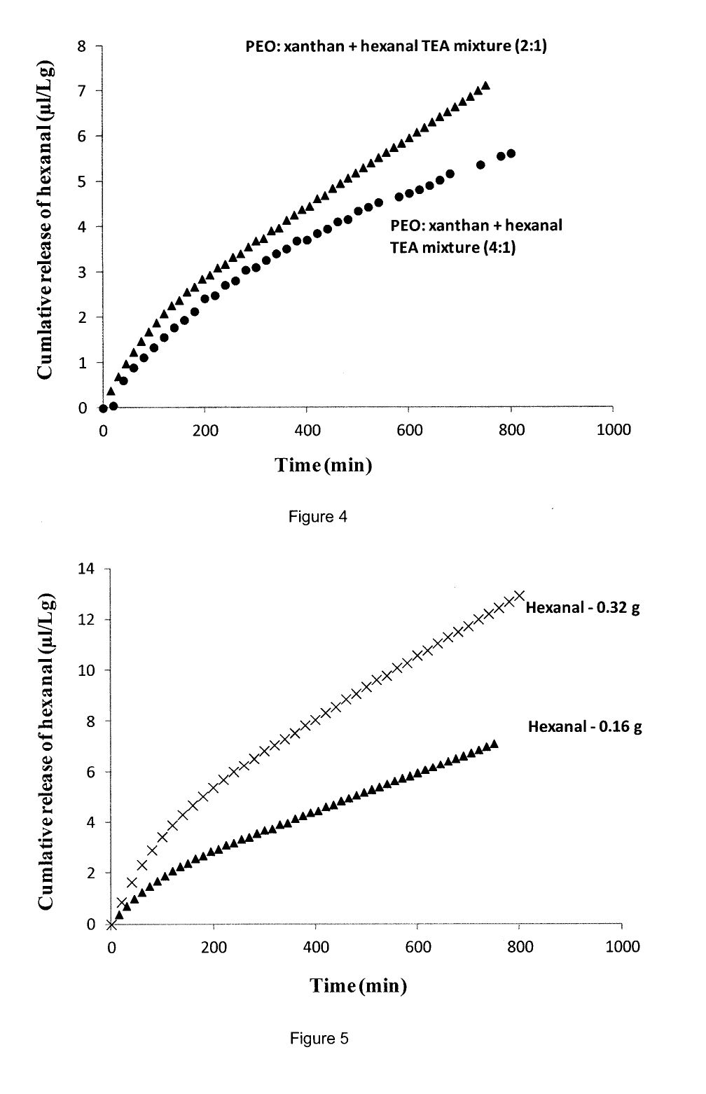

The different release kinetics can be achieved not only by changing the structure of fiber matrix, but also by manipulating the component ratio of the formula. FIG. 4 shows the effect of PEO content in the formulation on the cumulative headspace release of hexanal for 800 min. Increasing PEO ratio by 4:1 (PEO: (xanthan+TEA+hexanal mixture) decreased the release rate of hexanal due to the increased thickness of the barrier layer for hexanal through the encapsulated fibers.

FIG. 5 illustrates the effect of hexanal loading on release rate. It is clear from the figure that an increase in hexanal concentration increased the release rate. The calculated release rate of hexanal at 200 min was 0.026 μl/L·g·min. Hexanal concentration in the formulation was directly proportional to its release within the tested experimental condition, showing that hexanal loading can be changed to achieve the required release profile for the fresh products.

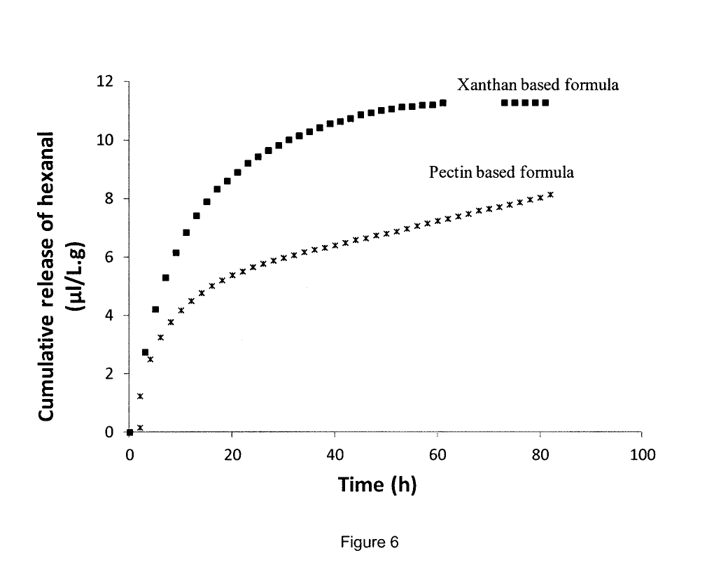

Release kinetics are dependent on the encapsulation materials used for the formulation of the fiber-forming solutions. As shown in FIG. 6, a relatively low release rate was observed in formula based on pectin compared with xanthan. This different release behaviour can be attributed to different charges of the polysaccharides, viscosity, propensity of gel formation, viscoelastic properties of the solution, and component interaction between hexanal, TEA, and PEO. Two different release rates were observed with pectin-based formula. During the first 20 h, the release rate observed was similar to xanthan gum. But after 20 h, the release rate decreased substantially compared with gum xanthan. This behaviour may be suitable for certain applications where in initial burst release and then gradual release of hexanal are desirable.

### Example 2

### Preparation of Carnauba Wax Based Formula for Electrospinninq

The encapsulation of hexanal in an amphiphilic media may increase the interaction between hexanal and hydrophobic material due to hydrophobic interaction, thereby reducing the release rate of hexanal. In accordance with another aspect of the invention, a new formula was developed by dissolving carnauba wax in the aqueous-based fiber-forming solution. In this formulation, 0.5 g carnauba wax was added to 5 g of milky solution of gum xanthan, TEA and hexanal mixture mentioned in Example 1. This mixture was then heated to the temperature of 85-100° C. by using magnetic stirrer in a hermetically sealed glass bottle. After the carnauba wax uniformly dispersed in the xanthan gum and hexanal mixture, the solution was cooled to room temperature to entrap hexanal in the carnauba wax. Finally, to this solution, 15 g of 4% PEO in 30% ethanol was added and mixed for 30 min by using a magnetic stirrer to make the complete suspension.

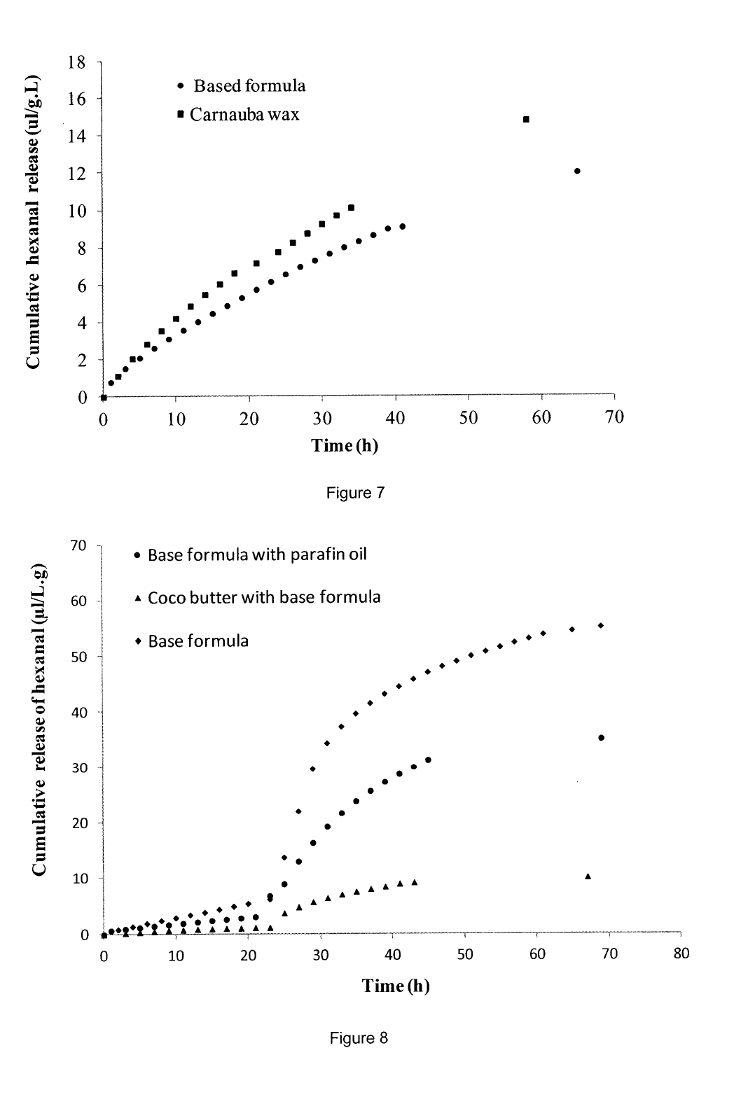

While carnuaba wax has been used for the controlled release of drugs (Huang et al., 1994) and coating of fruits to prevent weight loss, limited research was available for aqueous carnauba wax based system for the encapsulation of volatile compound. No literature can be found on the use of carnauba, in conjunction with electrospun fiber carrier, for controlled release of volatile compound. In this example, we hypothesized that carnauba wax and hexanal can form carnauba-hexanal crystal complexes during electrospinning. As can be seen in FIG. 7, the zero order release kinetic was observed after incorporating carnauba wax into the base formulation. Compared to the electrospun fibers made with the base formula, surprisingly higher release rate was observed with the electrospun fibers modified with carnauba wax. After 10 hrs, the release rate of base formula decreased due to higher sensitivity to moisture, causing the fibers to collapse, thereby reducing the available surface area for permeation.

### Example 3

### Preparation of Paraffin Oil Based Formula for Electrospinning

In this example, paraffin oil was used with the base formula described in Example 1 consisting of hexanal, TEA, xanthan gum, and PEO. Paraffin oil is hydrophobic that can decrease the hydrophilicity of the electrospun fibers. Moreover, the hydrophobic interaction between hexanal and paraffin oil will cause hexanal to partition into the lipid phase, thereby modifying the release pattern of hexanal. In this alternate formula, 0.5 g paraffin oil was added to 5 g of milky solution of xanthan gum, TEA and hexanal mixture. This mixture was then heated to 85-100° C. by mixing with a magnetic stirrer in a hermetically sealed glass bottle. After the paraffin oil was completely dispersed in the xanthan gum, TEA, and hexanal mixture, an aliquot of 12 g of 4% PEO in 30% ethanol was added and further mixed for 30 min by using magnetic stirrer to make the complete suspension. It was cooled at room temperature before being electrospun into nonwoven fibrous membrane.

Paraffin oil was added to the base formula to reduce the moisture sensitivity of the electrospun fibers as well as the release rate at the room temperature. As can be seen in FIG. 8, the dramatic increase of hexanal release rate was caused by the increase of the temperature from 23° C. to 45° C., by almost two times. The observed release rate of hexanal at 23° C. for 20 h was 0.129 μl/L·g·h, whereas it was 0.430 μl/L·g·h at 45° C. These observations indicate that increasing the storage temperature can trigger the release of hexanal from the fibers produced using the above composition. This variant of thermal-sensitive electrospun fibers is suitable for tackling the temperature fluctuation abuses occurred during distribution of fresh produce, which is prevalent in developing countries where proper cold storage facilities are not readily available.

### Example 4

### Preparation of Coco Butter Based Formula for Electrospinning

It is advantageous to develop an interactive delivery system hexanal that can be triggered by temperature, such as when food products are exposed to temperature abuse. This effect can be achieved by encapsulating hexanal in electrospun fibers made from temperature-sensitive materials, such as those derived from lipids that possess melting points that are greater than the product storage temperature. For this purpose, different fats and waxes can be used that show crystal network at room temperature. By judicially trapping hexanal in these fat crystal networks, the release of hexanal can be activated by melting the fat crystals when the storage temperature exceeds the melting point of the lipid materials. In one embodiment, coco butter was chosen for this purpose since it has a propensity of forming crystallites of different polymorphs of different melting points (Loisel et al., 1998; Marangoni and McGauley, 2003). A new formula was developed by entrapping hexanal in a coco butter crystal structure. Here, 0.5 g of melted coco butter was mixed with 5 g of a milky solution of xanthan gum, TEA and hexanal mixture described in Example 1. This mixture was then heated to around 40-45° C. by using magnetic stirrer in a hermetically sealed glass bottle. It was then cooled to room temperature to form a stable suspension. To this cooled suspension, 12 g of 4% PEO in 30% ethanol was added and mixed for 30 min by using magnetic stirrer to make the final emulsion suitable for electrospinning.

In this example, a novel method was developed to encapsulate hexanal in the electrospun fibers that are thermal sensitive. This method was based on the formation of the complexes between fat crystal network and hexanal. Temperature can be used to trigger the release of hexanal, because an increase of temperature up to the melting point of the fat will melt the crystal, thereby liberating hexanal. In this example, coco butter was used, since it shows the six different crystal structures at different temperatures (Marangoni and McGauley, 2003). The melting temperatures of coco butter were changed from −5 to 34° C. as reported in the literature (Marangoni and McCauley, 2003). Exposing the crystalline lipid above 34° C. will melt all the crystallites, thereby triggering the release of hexanal. On the other hand, below this temperature, the cocoa butter will exist as a mixture of crystal/amorphous structures. FIG. 8 shows the cumulative release of hexanal at 23 and 45° C. with the electrospun fibers made by coco butter with base formula. The release rate of hexanal at 23° C. was very low compared with the electrospun fibers kept at 45° C. The release rate of hexanal at 23° C. was 0.006 μl/L·g·h during the initial phase, but increased to 0.201 μl/L·g·h as temperature increased to 45° C. At the initial stage it showed a lag period, indicating that diffusion rate of hexanal was low in this fiber matrix.

Comparing the release of hexanal from the electrospun fibers made with paraffin oil, cocoa butter and xanthan based formula, it was demonstrated that the highest release was observed with the base formula, and the lowest release was observed with cocoa butter. From this observation, it was concluded that hexanal-xanthan structure was weaker compared with the coco butter-hexanal crystal complexes.

These findings show that the methodologies that we presented here are useful to engineer hexanal delivery systems with different hexanal release profiles at different temperatures.

### Effect of Temperature on Release

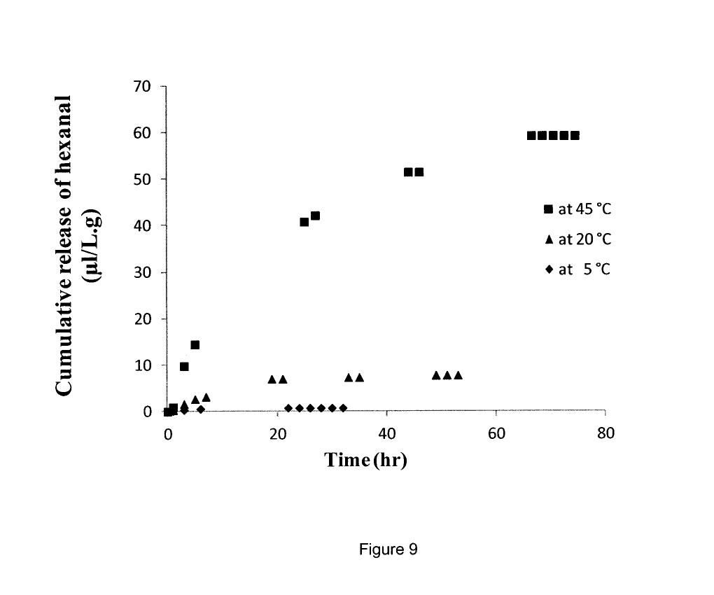

FIG. 9 shows the effect of temperature on release rate of hexanal at 3 different temperatures. At 5° C., the release of hexanal was comparatively low compared with temperatures at 20 and 45° C. The highest release rate was observed at 45° C. This higher release rate at higher temperature can be attributed to the destruction of xanthan-hexanal crystal complexes at higher temperature as well as the increased kinetic energy of the permeate molecules. These results show that the release of hexanal can be triggered by a temperature increase.

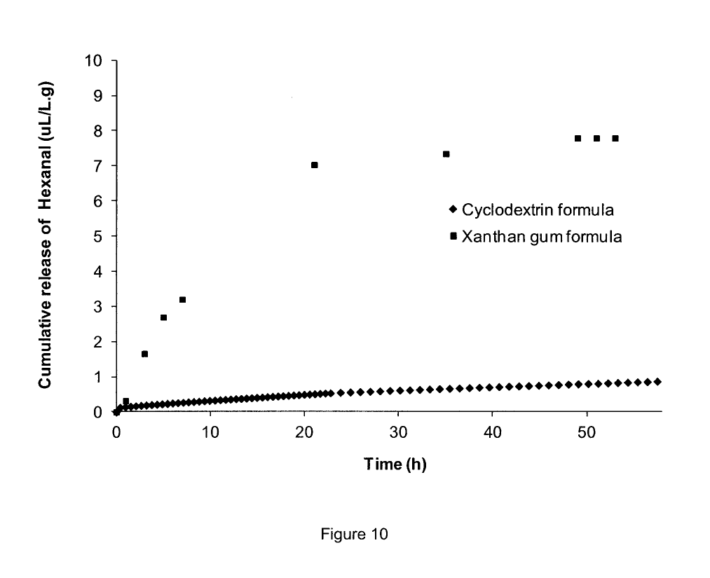

The advantages of the present invention can be elucidated by comparing with the existing methods. The present invention exhibits many advantages compared with the methods reported in the literature so far (Almenar et al., 2007a; Almenar et al., 2007b). As reported by Almenar (2007), the maximum headspace hexanal release at 23° C. and 100% RH for 3 days was 0.35 μg/L·g. This maximum release was obtained for 1845 μl of initial loading of hexanal. The maximum headspace release of hexanal observed in the electrospun fibers made with a xanthan gum based formula was 9.83 μg/L·g. The initial loading of hexanal for the xanthan based formula was 195 μl. According to this calculation, it can be concluded that the higher release rate was observed relative to the initial loading of hexanal in accordance with the present invention. Another advantage observed with this present invention is that there is no molar ratio requirement to encapsulate the hexanal with the encapsulating material. According to Almenar et al.'s (2007) findings, the cyclodextrin-complex approach required a molar ratio of 1:1 (cyclodexrin:hexanal) in order to encapsulate hexanal effectively. Therefore, with this present invention, the amount of material used can be reduced. Further, the higher release rate of the electrospun fibers also helps to reduce the amount of material. This higher release rate is attributed to the higher surface area to volume ratio of electrospun fibers. FIG. 10 shows the comparison of headspace hexanal release between the electrospun fibers made with xanthan based formula and cyclodextrin. By comparing these two release profiles, the efficacy of present invention is confirmed.

### Effects of Humidity on Release

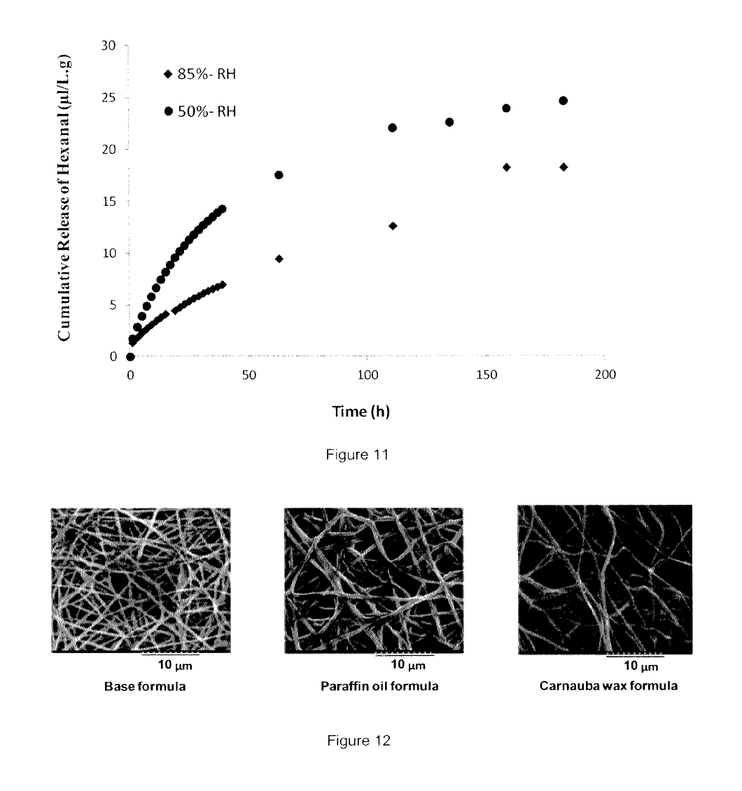

FIG. 11 shows the release kinetics of hexanal at 50 and 85% RH conditions. As shown, the release of hexanal was lower at 85% compared with the 50% RH. This can be attributed to the collapse of fibrous structure as it absorbed moisture from the surrounding environment. As a result, the available surface area of the nonwoven membrane for hexanal release was decreased. This result shows that hydrophilic polymer can be applied in the present invention to manipulate the release kinetics of the volatile.

Size of Fibers with Different Carrier Systems.

FIG. 12 shows scanning electron micrographs showing that the fiber diameters of hexanal carrier systems ranged from 300 to 500 nm. Diameter of the fibers produced with based formula, carnauba wax based formula, and paraffin oil base formula was 371±72, 358±90, and 473±85 nm, respectively.

### REFERENCES

Almenar, E., Auras, R., Harte, B., Rubino, M., (2007a). Micro-encapsulation of volatile compounds into cyclodextrins: A new technology to reduce post harvest losses. US 2007/0207981 A1.
Almenar, E., Auras, R., Rubino, M., Harte, B., (2007b). A new technique to prevent the main post harvest diseases in berries during storage: Inclusion complexes-cyclodextrin-hexanal. International journal of food microbiology 118(2), 164-172.
Basavaraju, K. C., Demappa, T., Rai, S. K., (2007). Miscibility studies of polysaccharide xanthan gum and PEO (polyethylene oxide) in dilute solution. Carbohydrate polymers 69(3), 462-466.
Corbo, M. R., Lanciotti, R., Gardini, F., Sinigaglia, M., Guerzoni, M. E., (2000). Effects of hexanal, trans-2-hexenal, and storage temperature on shelf life of fresh sliced apples. Journal of agricultural and food chemistry 48(6), 2401-2408.
Gonzalez-Aguilar, G. A., Villa-Rodriguez, J. A., Ayala-Zavala, J. F., Yahia, E. M., Improvement of the antioxidant status of tropical fruits as a secondary response to some postharvest treatments. Trends in Food Science & Technology 21(10), 475-482.
Huang, H. P., Mehta, S. C., Radebaugh, G. W., Fawzi, M. B., (1994). Mechanism of drug release from an acrylic polymer wax matrix tablet. Journal of pharmaceutical sciences 83(6), 795-797.
Ko, J. A., Kim, W. Y., Park, H. J., (2012). Effects of microencapsulated Allyl isothiocyanate (AITC) on the extension of the shelf-life of Kimchi. International journal of food microbiology 153(1), 92-98.
Kostansek, E. C., (2002). Delivery system for cyclopropenes. U.S. Pat. No. 6,426,319.
Lanciotti, R., Gianotti, A., Patrignani, F., Belletti, N., Guerzoni, M. E., Gardini, F., (2004). Use of natural aroma compounds to improve shelf-life and safety of minimally processed fruits. Trends in Food Science & Technology 15(3), 201-208.
Loisel, C., Keller, G., Lecq, G., Bourgaux, C., Ollivon, M., (1998). Phase transitions and polymorphism of cocoa butter. Journal of the American Oil Chemists' Society 75(4), 425-439.
Marangoni, A. G., McGauley, S. E., (2003). Relationship between crystallization behavior and structure in cocoa butter. Crystal growth & design 3(1), 95-108.
Mirhosseini, H., Tan, C. P., Hamid, N. S. A., Yusof, S., (2008). Effect of Arabic gum, xanthan gum and orange oil contents on potential, conductivity, stability, size index and pH of orange beverage emulsion. Colloids and Surfaces A: Physicochemical and Engineering Aspects 315(1), 47-56.
Paliyath, G., Subramanian, J., (2008). Phospholipase D inhibition technology for enhancing shelf life and quality. Postharvest Biology and Technology of Fruits, Vegetables, and Flowers, pp 240-. Wiley Blackwell, Iowa.
Paliyath, G., Yada, R., Muir, D. P., Pinhero, R. G., (2003). Inhibition of phospholipase D. U.S. Pat. No. 6,514,914
Sharma, M., Jacob, J. K., Subramanian, J., Paliyath, G., (2010). Hexanal and 1-MCP treatments for enhancing the shelf life and quality of sweet cherry (Prunus avium L.). Scientia Horticulturae 125(3), 239-247.
Sudheer, K. P., Indira, V., (2007). Post harvest technology of horticultural crops. New India Publishing.
Talukdar, M. M., Kinget, R., (1997). Comparative study on xanthan gum and hydroxypropylmethyl cellulose as matrices for controlled-release drug delivery. II. Drug diffusion in hydrated matrices. International journal of pharmaceutics 151(1), 99-107.
Talukdar, M. M., Michoel, A., Rombaut, P., Kinget, R., (1996). Comparative study on xanthan gum and hydroxypropylmethyl cellulose as matrices for controlled-release drug delivery I. Compaction and in vitro drug release behaviour. International journal of pharmaceutics 129(1), 233-241.
Thavong, P., Archbold, D. D., Pankasemsuk, T., Koslanund, R., Postharvest use of hexanal vapor and heat treatment on longan fruit decay and consumer acceptance. Thammasat Int. J. Sc. Tech 15(4).
Tiwari, K and G. Paliyath (2011) Microarray analysis of ripening-regulated gene expression and its modulation by 1-MCP and hexanal. Plant Physiol. Biochem., 49, 329-340.
Utto, W., Mawson, A. J., Bronlund, J. E., (2008). Hexanal reduces infection of tomatoes by Botrytis cinerea whilst maintaining quality. Postharvest Biology and Technology 47(3), 434-437.

1. A method for encapsulating a volatile organic compound, the method comprising:
preparing a stabilized system of biopolymer, surfactant, and volatile organic compound (VOC);
mixing an encapsulating polymer solution with said stabilized system to form a fiber forming solution; and
producing ultrafine fibers from the fiber forming solution, wherein said VOC is encapsulated therein.

2. (canceled)

3. The method of claim 1, wherein the volatile organic compound is selected from the group consisting of C₆ aldehydes, C₆ alcohols, monoterperne aldehydes, monoterpene alcohols, cyclopropene, methylcyclopropene, allyl-isothiocyanate, acetaldehyde, hexanal, 2E-hexanal, cinnamic acid, 1-methylcyclopropene, isoprene, terpenes, jasmonate, benzaldehyde, propanal, butanol, ethanol, acetic acid, thymol, eugenol, citral, vanillin, transcinamaldehyde, salicyclic acid, furfural, geraniol, 2-nonanone, cis-3 hexen-1-ol, and combinations thereof.

4-6. (canceled)

7. The method of claim 6, wherein the surfactant is selected from the group consisting of triethanolamine (TEA), glycerol, triethylene glycol (TEG), Tween 20, Tween 40, polysorbates, lecithin, Span 80, Span 85, polyethylene glycol (PEG) and combinations thereof.

8. The method of claim 7, wherein said volatile organic compound is hexanal and said surfactant is TEA.

9. (canceled)

10. The method of claim 1, wherein the biopolymer is selected from the group consisting of polysaccharide, protein and combinations thereof.

11. The method of claim 10, wherein the polysaccharide is selected from the group consisting of pectin, alginate, guar gum, carrageenan, waxy corn starch, and combinations thereof, and wherein the protein is selected from the group consisting of zein, gelatin, soy protein, whey protein isolates, chitosan, and mixtures thereof.

12-16. (canceled)

17. The method of claim 1, wherein said stabilized system is an emulsion, dispersion or solution.

18. The method of claim 1, wherein said encapsulating polymer solution comprises polyethylene oxide (PEO), polyvinyl acetate (PVA), hydroxypolymethylcellulose (HPMC), poly(vinylpyrrolidinone)(PVP), poly(acrylic acid)(PAA), poly(methacrylic acid, polyethylenimine (PEI), poly(lactic acid) (PLA), nylon, polydimethylsiloxane (PDMS), or mixtures thereof in a hydrophobic solvent.

19-21. (canceled)

22. The method of claim 1, further comprising adding a volatile organic compound binding agent to the stabilized system.

23-27. (canceled)

28. The method of claim 1, wherein said ultrafine fibers are formed by a process selected from electrospinning, solution dry spinning, melt blown, dispensing using pressurized air jets, and combinations thereof.

29. (canceled)

30. The method of claim 28, wherein the ultrafine fibers formed by electrospinning are electrospun as a film, membrane, coating, patch, mat, sheet or lining.

31. (canceled)

32. The method of claim 28, further comprising electrospraying the fiber forming solution to form particles on said fibers.

33-35. (canceled)

36. An ultrafine fiber composition comprising a polymer matrix and an encapsulated volatile organic compound, wherein the polymer matrix provides for a desired release kinetic of the volatile organic compound.

37. The composition of claim 36, wherein said polymer matrix comprises a biopolymer, surfactant and encapsulating polymer.

38. The composition of claim 37, wherein the surfactant is selected from the group consisting of triethanolamine (TEA), glycerol, triethylene glycol (TEG), Tween 20, Tween 40, polysorbates, lecithin and combinations thereof.

39. (canceled)

40. The composition of claim 37, wherein the biopolymer is a polysaccharide, a protein, or a combination thereof.

41. The composition of claim 40, wherein the polysaccharide is selected from the group consisting of pectin, alginate, guar gum, carrageenan, waxy corn starch, chitosan, and mixtures thereof, and wherein the protein is selected from the group consisting of zein, gelatin, soy protein, whey protein isolates, and mixtures thereof.

42-46. (canceled)

47. The composition of claim 36, wherein the volatile organic compound is selected from the group consisting of C₆ aldehydes, C₆ alcohols, monoterperne aldehydes, monoterpene alcohols, cyclopropene, methylcyclopropene, allyl-isothiocyanate, acetaldehyde, hexanal, 2E-hexanal, cinnamic acid, 1-methylcyclopropene, isoprene, terpenes, jasmonate, benzaldehyde, propanal, butanol, ethanol, acetic acid, thymol, eugenol, citral, vanillin, trans-cinamaldehyde, salicyclic acid, furfural, geraniol, 2-nonanone, cis-3 hexen-1-ol, and combinations thereof.

48. The composition of claim 47, wherein the volatile organic compound is hexanal or 2E-hexanal.

49. The composition of claim 37, wherein said encapsulating polymer solution comprises polyethylene oxide (PEO), polyvinyl acetate (PVA), hydroxypolymethylcellulose (HPMC), poly(vinylpyrrolidinone)(PVP), poly(acrylic acid)(PAA), poly(methacrylic acid, polyethylenimine (PEI), polyimethylsiloxane (PDMS), nylon, poly{lactic acid)(PLA) and mixtures thereof in a hydrophobic solvent.

50. (canceled)

51. The composition of claim 36, further comprising a VOC binding agent.

52. The composition of claim 51, wherein the VOC binding agent is a temperature sensitive substance selected from the group consisting of a wax, oil, lipid, or combinations thereof.

53-58. (canceled)

59. The composition of claim 58, wherein the fibers form a film, membrane, coating, patch, sheet or lining.

60-62. (canceled)

63. The composition of claim 36 in combination with a perishable product that is edible or non-edible.

64-65. (canceled)

66. The composition of claim 65, wherein said ultrafine fibers are between about 300 to about 500 nm in diameter.

67. The composition of claim 36, further comprising VOC encapsulated particles.

68-69. (canceled)

70. A method for encapsulating hexanal for the preservation of perishable foods, the method comprising:
(a) mixing hexanal with triethanolamine to form a conditioned mixture;
(b) adding xanthan gum to said conditioned mixture and forming a stable emulsion at about room temperature;
(c) adding one or more hexanal-binding compounds selected from an oil, wax, fat or combinations thereof to said stable emulsion;
(d) mixing an encapsulating polymer solution comprising polyethylene oxide with said stable emulsion to form a fiber forming solution; and
(e) electro-spinning the fiber forming solution to form ultrafine fibers.

71. A container capable of retarding decay, maturation and senescence of perishable fruits, vegetables and florals, in postharvest circumstances, said container comprising a lining, coating or insert comprising the ultrafine fiber composition comprising a polymer matrix and encapsulated volatile organic compound of claim 36 and an optional binding compound.

72. (canceled)

73. A method for increasing the shelf-life of perishable food or horticultural products, the method comprising:
enclosing or placing adjacent the perishable food or horticultural product with a composition comprising the ultrafine fiber composition comprising a polymer matrix and encapsulated volatile organic compound of claim 36 and an optional VOC binding compound, the polymer matrix comprising a biopolymer selected from the group consisting of polysaccharide and protein, and surfactant selected from the group consisting of triethanolamine, glycerol, triethylene glycol, Tween 20, Tween 40, polysorbates, lecithin and combinations thereof;
wherein the volatile organic compound is selected from the group consisting of C₆ aldehydes, C₆ alcohols, monoterperne aldehydes, monoterpene alcohols, cyclopropene, methylcyclopropene, allyl-isothiocyanate, acetaldehyde, hexanal, 2E-hexanal, cinnamic acid, 1-methylcyclopropene, isoprene, terpenes, jasmonate, benzaldehyde, propanal, butanol, ethanol, acetic acid, thymol, eugenol, citral, vanillin, trans-cinamaldehyde, salicyclic acid, furfural, geraniol, 2-nonanone, cis-3 hexen-1-ol, and combinations thereof.

74-75. (canceled)
